(19) United States
(12) Patent Application Publication
(10) Pub. No.: US 2012/0189933 A1
(43) Pub. Date: Jul. 26, 2012

(54) ANODE CATALYST LAYERS FOR DIRECT OXIDATION FUEL CELLS

(76) Inventors: Chao-Yang WANG, State College, PA (US); Lei Cao, State College, PA (US); Hiroaki Matsuda, Osaka (JP)

(21) Appl. No.: 13/013,375

(22) Filed: Jan. 25, 2011

(51) Int. Cl. H01M 8/04; B05D 5/12; H01M 4/96; H01M 8/10; H01M 4/92

(52) U.S. Cl. 429/443; 429/480; 429/524; 427/77

(57) ABSTRACT

A direct oxidation fuel cell (DOFC) and a method of fabricating the DOFC such that the DOFC reduces overpotential. The DOFC includes a cathode electrode; an anode electrode; and a polymer electrolyte membrane (PEM) sandwiched between the cathode and the anode. Each of the cathode electrode and anode electrode include a catalyst layer and a gas diffusion layer (GDL) and the anode electrode catalyst layer includes platinum (Pt), ruthenium (Ru) and a small amount of SnO₂ supported on carbon powder.

### FIELD OF THE DISCLOSURE

The present disclosure relates generally to fuel cells, fuel cell systems, and catalyst containing electrodes for use in membrane electrode assemblies of direct oxidation fuel cells. More specifically, the present disclosure relates to catalyst layers for use in electrodes utilized in membrane electrode assemblies comprising polymer electrolyte membranes for direct oxidation fuel cells, such as direct methanol fuel cells, and their method of fabrication.

### BACKGROUND OF THE DISCLOSURE

A direct oxidation fuel cell (hereinafter “DOFC”) is an electrochemical device that generates electricity from electrochemical oxidation of a liquid fuel. DOFC's do not require a preliminary fuel processing stage; hence, they offer considerable weight and space advantages over indirect fuel cells, i.e., cells requiring preliminary fuel processing. Liquid fuels of interest for use in DOFC's include methanol (“MeOH”), formic acid, dimethyl ether, etc., and their aqueous solutions. The oxidant may be substantially pure oxygen or a dilute stream of oxygen, such as that in air. Significant advantages of employing a DOFC in portable and mobile applications (e.g., notebook computers, mobile phones, personal data assistants, etc.) include easy storage/handling and high energy density of the liquid fuel.

One example of a DOFC system is a direct methanol fuel cell (hereinafter “DMFC”). A DMFC generally employs a membrane-electrode assembly (hereinafter “MEA”) having an anode, a cathode, and a proton-conducting polymer electrolyte membrane (hereinafter “PEM”) positioned therebetween. A typical example of a PEM is one composed of an ionomeric perfluorosulfonic acid-tetrafluorethylene copolymer having a hydrophobic fluorocarbon backbone and perfluoroether side chains containing a strongly hydrophilic pendant sulfonic acid group (SO₃H), such as NAFION® (Nafion® is a registered trademark of E.I. Dupont de Nemours and Company). When exposed to H₂O, the hydrolyzed form of the sulfonic acid group (SO₃⁻H₃O⁺) allows for effective proton (H⁺) transport across the membrane, while providing thermal, chemical, and oxidative stability. In a DMFC, a methanol/water solution is directly supplied to the anode as the fuel and air is supplied to the cathode as the oxidant. At the anode, the methanol reacts with the water in the presence of a catalyst, typically a Pt—Ru alloy-based catalyst, to produce carbon dioxide, H⁺ ions (protons), and electrons. The electrochemical reaction is shown as equation (1) below:

CH₃OH+H₂O→CO₂+6H⁺+6e⁻ (1)

During operation of the DMFC, the protons (i.e., H⁺ ions) migrate to the cathode through the proton-conducting membrane electrolyte, which is non-conductive to electrons (e⁻). The electrons travel to the cathode through an external circuit for delivery of electrical power to a load device. At the cathode, the protons, electrons, and oxygen molecules, typically derived from air, are combined to form water. The electrochemical reaction is given in equation (2) below:

3/2O₂+6H⁺+6e⁻→3H₂O (2)

Electrochemical reactions (1) and (2) form an overall cell reaction as shown in equation (3) below:

CH₃OH+3/2O₂→CO₂+2H₂O (3)

The ability to use highly concentrated fuel is desirable for portable power sources, particularly since DMFC technology is currently competing with advanced batteries, such as those based upon lithium-ion technology.

In practice, however, liquid fuel electrochemical oxidation reactions, such as that shown for MeOH in equation (1) supra, do not proceed as readily as that for hydrogen (H₂). As a consequence, a principal factor in the lowering of electrical performance of DOFCs, e.g., DMFCs, occurs due to the presence of significant activation energy overvoltages (η_{act}) at the anode and cathode electrodes.

Typically, an alloy of platinum (Pt) and ruthenium (Ru) is utilized as a catalyst for the oxidation reaction at the anode electrode (as expressed in eq. (1)), and Pt is utilized as a catalyst for the reduction reaction at the cathode electrode (as expressed in eq. (2) supra). A currently utilized approach for reducing activation energy overvoltages at the anode and cathode electrodes, as well as for mitigating carbon monoxide (CO) poisoning of the anode and mixed potential generation at the cathode, is to utilize high loading of the precious metal-based catalysts, e.g., loading at levels about tenfold greater than with hydrogen/air fuel cells. Disadvantageously, however, this represents a significant obstacle for cost-effective commercialization of DOFC/DMFC technology for use as portable power sources due to the high cost of precious metals.

In view of the foregoing, there exists a need for improved catalyst layers for electrodes for MEAS and DOFC/DMFC systems, as well as methodologies for fabricating the same.

### SUMMARY OF THE DISCLOSURE

Advantages of the present disclosure include a supported catalyst layer for use in a fuel cell electrode, their manufacturing methodology, and their use in an electrode of a direct oxidation fuel cell (DOFC), such as a direct methanol fuel cell (DMFC).

Still other advantages of the present disclosure are improved electrodes and MEAS for DOFCs and DMFCs.

Additional advantages and features of the present disclosure will be set forth in the disclosure which follows and in part will become apparent to those having ordinary skill in the art upon examination of the following or may be learned from the practice of the present disclosure. The advantages may be realized and obtained as particularly pointed out in the appended claims.

In one aspect of the present disclosure, a direct oxidation fuel cell (DOFC) is configured to comprise a cathode electrode; an anode electrode; and a polymer electrolyte membrane (PEM) sandwiched between the cathode and the anode. The DOFC also comprises a fuel source containing a highly concentrated fuel in fluid communication with the anode; and an oxidant in fluid communication with the cathode. Furthermore, each of the cathode electrode and anode electrode comprise a catalyst layer and a gas diffusion layer (GDL). The anode electrode catalyst layer comprises platinum (Pt), ruthenium (Ru) and tin dioxide (SnO₂) supported on carbon powder. The amount of SnO₂ in the catalyst layer is equal to or lower than about 6.9 wt % relative to total weight of the Pt, Ru and SnO₂ catalyst layer. The ratio of Pt:RU:SnO₂ in the catalyst is preferably about 6:6:1.

Embodiments may include one or more of the following features. The anode electrode catalyst may further comprise at least one ionomeric polymer. The at least one ionomeric polymer may comprise a perfluorosulfonic acid-tetrafluorethylene copolymer having a hydrophobic fluorocarbon backbone and perfluoroether side chains containing a pendant sulfonic acid group (SO₃H). The DOFC may further comprise a liquid gas (L/G) separator configured to receive water produced at the cathode and excess fuel from the anode. In addition, the DOFC may comprises a controller programmed to control oxidant stoichiometry of the DOFC. The catalyst layer may be deposited on the surface of the GDL or PEM directly, and the GDL may be a porous carbon-based material having a porosity of about 20%-80%. Furthermore, the PEM may comprise a fluorinated polymer having a perfluorosulfonate group or a hydrocarbon polymer. The PEM may have a thickness between about 25 μm to 200 μm.

In another aspect, the instant disclosure describes a method, which involves fabricating a direct oxidation fuel cell (DOFC), comprising depositing a catalyst ink layer on a porous carbon based substrate or the PEM, wherein the catalyst ink layer is formed by combing platinum (Pt), ruthenium (Ru) and SnO₂ supported on a carbon powder, and the amount of SnO₂ in the catalyst layer is equal to or lower than 6.9 wt % relative to total weight of the Pt, Ru and SnO₂ catalyst layer.

In another aspect, the instant disclosure describes an anode electrode for use in a direct oxidation fuel cell, comprising a fluid catalyst ink layer on a porous carbon based substrate, wherein the fluid catalyst ink layer is formed by combing platinum (Pt), ruthenium (Ru) and SnO₂ supported on a carbon powder, and the amount of SnO₂ in the catalyst layer is equal to or lower than about 6.9 wt %.

### BRIEF DESCRIPTIONS OF THE DRAWINGS

The drawing figures depict one or more implementations in accord with the present teachings, by way of example only, not by way of limitation. In the figures, like reference numerals refer to the same or similar elements.

FIG. 1 is a simplified, schematic illustration of a DOFC system capable of operating with highly concentrated methanol fuel, i.e., a DMFC system;

FIG. 2 is a schematic, cross-sectional view of a representative configuration of a MEA suitable for use in a fuel cell/fuel cell system such as the DOFC/DMFC system of FIG. 1;

FIG. 3 is a graph illustrating the variation of discharge voltage vs. current densities of anodes in DMFC applications, for comparing the performance of C-supported Pt—Ru catalyst layers with and without varying amounts of SnO₂;

FIG. 4 is a graph illustrating the variation of IR-free overpotential (V) for anodes in DMFC applications with varying amounts of SnO₂.

### DETAIL DESCRIPTION OF THE DISCLOSURE

The present disclosure relates to fuel cells and fuel cell systems with high power conversion efficiency, such as DOFC's and DOFC systems operating with highly concentrated fuel, e.g., DMFC's and DMFC systems fueled with about 2 to about 25 M MeOH solutions, improved catalyst layers for use in electrodes/electrode assemblies therefor, and to methodology for fabricating same.

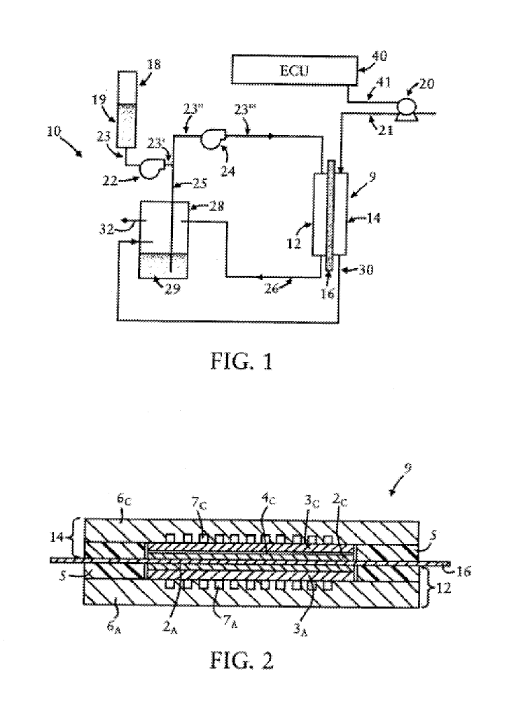

Referring to FIG. 1, schematically shown therein is an illustrative embodiment of a DOFC system adapted for operating with highly concentrated fuel, e.g., a DMFC system 10, which system maintains a balance of water in the fuel cell and returns a sufficient amount of water from the cathode to the anode under high-power and elevated temperature operating conditions.

As shown in FIG. 1, DMFC system 10 includes an anode 12, a cathode 14, and a proton-conducting PEM 16, forming a multi-layered composite membrane-electrode assembly or structure 9 commonly referred to as an MEA. Typically, a fuel cell system such as DMFC system 10 will have a plurality of such MEA's in the form of a stack; however, FIG. 1 shows only a single MEA 9 for illustrative simplicity. Frequently, the MEA's 9 are separated by bipolar plates that have serpentine channels for supplying and returning fuel and by-products to and from the assemblies (not shown for illustrative convenience). In a fuel cell stack, MEAS and bipolar plates are aligned in alternating layers to form a stack of cells and the ends of the stack are sandwiched with current collector plates and electrical insulation plates, and the entire unit is secured with fastening structures. Also not shown in FIG. 1, for illustrative simplicity, is a load circuit electrically connected to the anode 12 and cathode 14.

A source of fuel, e.g., a fuel container or cartridge 18 containing a highly concentrated fuel 19 (e.g., methanol), is in fluid communication with anode 12 (as explained below). An oxidant, e.g., air supplied by fan 20 and associated conduit 21, is in fluid communication with cathode 14. The highly concentrated fuel from fuel cartridge 18 is fed directly into liquid/gas (hereinafter “L/G”) separator 28 by pump 22 via associated conduit segments 23′ and 25, or directly to anode 12 via pumps 22 and 24 and associated conduit segments 23, 23′, 23″, and 23″.

In operation, highly concentrated fuel 19 is introduced to the anode side of the MEA 9, or in the case of a cell stack, to an inlet manifold of an anode separator of the stack. Water produced at the cathode 14 side of MEA 9 or cathode cell stack via electrochemical reaction (as expressed by equation (2)) is withdrawn therefrom via cathode outlet or exit port/conduit 30 and supplied to L/G separator 28. Similarly, excess fuel (MeOH), H₂O, and CO₂ gas are withdrawn from the anode side of the MEA 9 or anode cell stack via anode outlet or exit port/conduit 26 and supplied to L/G separator 28. The air or oxygen is introduced to the cathode side of the MEA 9 and regulated to maximize the amount of electrochemically produced water in liquid form while minimizing the amount of electrochemically produced water vapor, thereby minimizing the escape of water vapor from system 10.

During operation of system 10, air is introduced to the cathode 14 (as explained above) and excess air and liquid water are withdrawn therefrom via cathode exit port/conduit 30 and supplied to L/G separator 28. As discussed further below, the input air flow rate or air stoichiometry is controlled to maximize the amount of the liquid phase of the electrochemically produced water while minimizing the amount of the vapor phase of the electrochemically produced water. Control of the oxidant stoichiometry ratio can be obtained by setting the speed of fan 20 at a rate depending on the fuel cell system operating conditions or by an electronic control unit (hereinafter “ECU”) 40, e.g., a digital computer-based controller or equivalently performing structure. ECU 40 receives an input signal from a temperature sensor in contact with the liquid phase 29 of L/G separator 28 (not shown in the drawing for illustrative simplicity) and adjusts the oxidant stoichiometry ratio (via line 41 connected to oxidant supply fan 20) to maximize the liquid water phase in the cathode exhaust and minimize the water vapor phase in the exhaust, thereby reducing or obviating the need for a water condenser to condense water vapor produced and exhausted from the cathode of the MEA 2. In addition, ECU 40 can increase the oxidant stoichiometry beyond the minimum setting during cold-start in order to avoid excessive water accumulation in the fuel cell.

Liquid water 29 which accumulates in the L/G separator 28 during operation may be returned to anode 12 via circulating pump 24 and conduit segments 25, 23″, and 23′″. Exhaust carbon dioxide gas is released through port 32 of L/G separator 28.

The DOFC/DMFC system 10 shown in FIG. 1 comprises at least one MEA 9 which includes a PEM 16 and a pair of electrodes (an anode 12 and a cathode 14) each composed of a catalyst layer and a gas diffusion layer sandwiching the membrane. Typical PEM materials include fluorinated polymers having perfluorosulfonate groups (as described above) or hydrocarbon polymers, e.g., poly-(arylene ether ether ketone) (hereinafter “PEEK”). The PEM can be of any suitable thickness as, for example, between about 25 and about 200 μm. The catalyst layer typically comprises platinum (Pt) and/or ruthenium (Ru) based metals, or alloys thereof. The anodes and cathodes are typically sandwiched by bipolar separator plates having channels to supply fuel to the anode and an oxidant to the cathode. A fuel cell stack can contain a plurality of such MEA's 9 with at least one electrically conductive separator placed between adjacent MEA's to electrically connect the MEA's in series with each other, and to provide mechanical support.

Referring now to FIG. 2, shown therein is a schematic, cross-sectional view of a representative configuration of a MEA 9 for illustrating its various constituent elements in more detail. As illustrated, a cathode electrode 14 and an anode electrode 12 sandwich a PEM 16 made of a material, such as described above, adapted for transporting hydrogen ions from the anode to the cathode during operation. The anode electrode 12 comprises, in order from PEM 16, a metal- or alloy-based catalyst layer 2_{A} in contact therewith, typically a layer of a Pt—Ru alloy, and an overlying gas diffusion layer (hereinafter “GDL”) 3_{A}; whereas the cathode electrode 14 comprises, in order from electrolyte membrane 16: (1) a metal-based catalyst layer 2_{C} in contact therewith, typically a Pt layer; (2) an intermediate, hydrophobic micro-porous layer (hereinafter “MPL”) 4_{C}; and (3) an overlying gas diffusion medium (hereinafter “GDM”) 3_{C}. GDL 3_{A} and GDM 3_{C} are each gas permeable and electrically conductive, and may be comprised of a porous carbon-based material including a carbon powder and a fluorinated resin, with a support made of a material such as, for example, carbon paper or woven or non-woven cloth, felt, etc. As indicated above, catalyst layers 2_{A} and 2_{C} are typically metal based and may, for example, comprise Pt and/or Ru. MPL 4_{C} may be formed of a composite material comprising an electrically conductive powder such as carbon black and a hydrophobic material such as PTFE.

Completing MEA 9 are respective electrically conductive anode and cathode separators 6_{A} and 6_{C} for mechanically securing the anode 12 and cathode 14 electrodes against PEM 16. As illustrated, each of the anode and cathode separators 6_{A} and 6_{C} includes respective channels 7_{A} and 7_{C} for supplying reactants to the anode and cathode electrodes and for removing excess reactants and liquid and gaseous products formed by the electrochemical reactions. Lastly, MEA 9 is provided with gaskets 5 around the edges of the cathode and anode electrodes for preventing leaking of fuel and oxidant to the exterior of the assembly. Gaskets 5 are typically made of an O-ring, a rubber sheet, or a composite sheet comprised of elastomeric and rigid polymer materials.

As indicated above, a drawback of conventional DOFCs/DMFCs is that liquid fuel electrochemical oxidation reactions, such as that shown for MeOH in equation (1) supra, do not proceed as readily as that for hydrogen (H₂). Consequently, a lowering of their electrical performance occurs due to the presence of significant activation energy overvoltages (η_{act}) at the anode and cathode electrodes. The currently utilized approach for reducing the activation energy overvoltages at the anode and cathode electrodes, as well as for mitigating carbon monoxide (CO) poisoning of the anode and mixed potential generation at the cathode, utilizes very high loading of the precious metal-based catalysts, such as Pt-based or Pt—Ru-based catalysts, at levels about tenfold greater than with hydrogen/air fuel cells. However, this approach requiring large amounts of expensive precious metals disadvantageously represents a significant obstacle for cost-effective commercialization of DOFC/DMFC technology for use as portable power sources.

The present disclosure describes catalyst layers for use in electrodes utilized in MEAS of DOFCs/DMFCs and fabrication methodology therefor, with reduced activation energy overvoltages for performing anodic oxidation of fuels such as MeOH. For example, porous catalysts can be fabricated according to the present disclosure, such as precious metal-based supported catalysts layers, e.g., Pt—Ru alloy-based, carbon (C)-supported catalyst layers, with low amounts of SnO₂ which achieve high rates of MeOH oxidation with much lower overpotential.

In terms of electrocatalysis, finely dispersed, nano-particulate precious metal-based catalysts such as Pt—Ru mixtures or alloys provide much higher active surface area per gram of catalyst material when supported on a high surface area powder, typically an electrically conductive carbon (C) powder, than when unsupported. The highly dispersed character of carbon-supported Pt—Ru (hereinafter “Pt—Ru/C”) is beneficial for achieving high MeOH oxidation efficiency in DMFCs. However, at low temperature the kinetics of methanol oxidation in DMFC's using conventional Pt—Ru/C electrocatalytic layers is still sluggish.

According to the present disclosure, a low amount of SnO₂ is added to platinum (Pt) and ruthenium (Ru) supported on carbon powder to form an anode electrode catalyst layer in a DOFC. As used in this disclosure, a low amount of SnO₂ is lower than about 8.0 wt % and higher than 2.0 wt %, preferably lower than 7.5 wt % and higher than 3.0 wt %, and more preferably, lower than 6.9 wt % and higher than 4.0 wt %, relative to total weight of the Pt, Ru and SnO₂ catalyst layer and ionomeric polymer catalyst layer. An ionomeric polymer such as a perfluorosulfonic acid-tetrafluorethylene copolymer having a hydrophobic fluorocarbon backbone and perfluoroether side chains containing a pendant sulfonic acid group (SO₃H) may also be added to the catalyst layer along with a solvent such as water, isopropanol and ethanol.

A typical process for fabricating catalyzed electrodes for use in DOFC/DMFC applications involves a wet printing technique. According to one such technique, a liquid dispersion, slurry, or ink containing precious metal catalyst powder such as Pt and Ru is applied to the surface of a sheet of a suitable support (substrate) material, typically a layer of porous, carbon-based material usable as a GDL by spraying or doctor blade application. According to another technique, the ink is applied to the surface of a sheet of a decal material, e.g., a Teflon® PTFE layer, to form a catalyst layer which is later separated therefrom. An ink suitable for fabricating improved catalyst layers according to the present disclosure can be prepared by mixing a supported catalyst such as Pt—Ru/C powder, e.g., 80% Pt—Ru alloy relative to the weight of PtRu/C catalyst and SnO₂ unsupported on a carbon material (Vulcan XC-72R, available from E-TEK, Inc.), Nafion® solution, isopropyl alcohol, and deionized water. As indicated above, the ink can be applied onto the surface of a substrate by any suitable conventional technique, in order to form the catalyst layer, such as by spraying deposition.

According to the present disclosure, loading of the supported precious metal catalyst, e.g., Pt—Ru/C loading, is optimized in order to provide a balance between the catalyst kinetics and mass transport capability. For example, loading of a Pt—Ru/C catalyst which is too low may not afford sufficient catalytic activity; whereas, loading of a Pt—Ru/C catalyst which is too high may result in formation of an excessively thick catalyst layer which establishes a significant obstacle (i.e., impediment) to fuel (e.g., MeOH) transport therethrough. Optimal Pt—Ru/C loading has been determined to be in the range from about 3 to about 4 mg/cm² in DMFC applications.

The content of ionomeric polymer (e.g., NAFION®), i.e., the ratio of weight of dry supported catalyst (e.g., Pt—Ru—SnO₂/C) to weight of dry ionomeric polymer, can also be optimized. Specifically, high ionomeric polymer content in the catalyst layer extends the 3-phase contact of the reactant, electrolyte, and catalyst, and increases its activity in 3-dimensions because of the ability of protons (H⁺ ions) to move about the entire thickness of the layer. Therefore, the higher the ionomeric polymer content, the higher the proton conductivity. However, notwithstanding this relationship, formation of a thick ionomeric polymer layer on the surface of the catalyst material at high ionomeric polymer contents causes adverse effects which impose a limit on catalyst utilization. For example, an optimal weight ratio of Pt—Ru— SnO₂/C to Nafion® in DMFC applications has been determined to be about 22%.

Although the use of supported precious metal-based catalysts (e.g., C-supported) enables a greater than about 50% reduction in the amount of metal catalyst (e.g., Pt, Ru SnO₂) vis-à-vis unsupported catalysts (i.e., about 6 to about 8 mg/cm²), the supported catalyst layers are thicker than the unsupported catalyst layers due to the inclusion of the support particles (e.g., carbon particles). The denser structure of the supported catalyst layers not only decreases the area available for electrochemical reaction, but also severely limits the transport of reactants (e.g., MeOH) therethrough.

In order to ensure better contact between PtRu and SnO₂, PtRu loading in PtRu/C is higher than 45 wt %, preferably higher than 72 wt %, and to mitigate Pt site blockage, a nominal atomic ratio of Pt:Ru:SnO₂ is lower than about 3:3:1 and higher than about 8:8:1.

Table 1 shows a comparison of Example fuel cells 1-5 having varying ratios of Pt: Ru: SnO₂.

TABLE 1

| | | | Anode | | IR-free |
|---|---|---|---|---|---|
| | | | Precious | IR-included | Anode |
| | | | Metal | Anode | Over- |
| Example | | SnO₂ | Loading | Overpotential | potential |
| Number | Pt:Ru:SnO₂ | wt % | (mg/cm²) | (mV) | (V) |
| 1 | 1:1:0 | 0 | 3.7 | 432 | 0.420 |
| 2 | 10:10:1 | 2.8 | 4.0 | 428 | 0.412 |
| 3 | 8:8:1 | 3.5 | 3.9 | 421 | 0.408 |
| 4 | 6:6:1 | 4.7 | 3.8 | 408 | 0.395 |
| 5 | 4:4:1 | 6.9 | 3.8 | 411 | 0.398 |

In Example 1, the anode catalyst ink is made by mixing 80 wt % PtRu/C with ionomer and solvent. In Example 2, SnO₂ particles are added into the ink with vigorous stirring. The nominal atomic ratio of Pt:Ru:SnO₂ is 10:10:1. In Examples 3, 4 and 5, the nominal atomic ratio of Pt:Ru:SnO₂ increased to 8:8:1, 6:6:1 and 4:4:1, respectively. The ink is then used to make anode catalyst layer in MEAS.

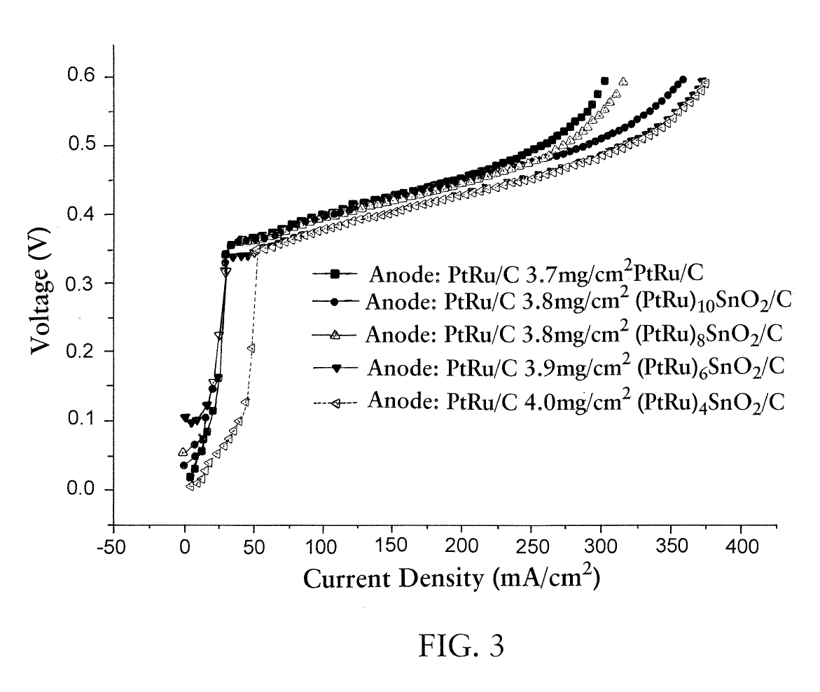

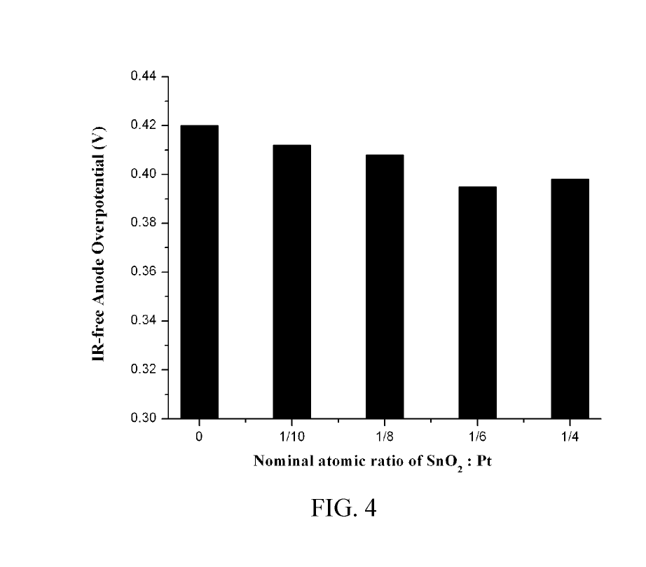

A direct evaluation of anode catalyst activity was obtained through anode overpotential comparison. Anode polarization curves were recorded at 40° C. while feeding MEAS with 4M methanol and hydrogen. The stoichiometry number, calculated at 150 mA/cm², was 2 for anode and 5 for cathode. As shown in FIG. 3, Example 1 not having SnO₂ present in the anode catalyst exhibited the highest overpotential of 432 mV at 150 mA/cm². The addition of a small amount of SnO₂ in Example 2 decreased anode overpotential to 428 mV at 150 mA/cm². The anode overpotential was further decreased along with the increase of SnO₂ content as shown in Example 3, having a Pt:Ru:SnO₂ of 8:8:1. A minimum, 408 mV at 150 mA/cm², was achieved when the nominal atomic ratio of Pt:Ru:SnO₂ was 6:6:1 in Example 4. After that the corresponding anode started to increase due to a possible blockage of Pt sites with more SnO₂. The results are displayed in FIG. 4 and compared in Table 1 with both IR-included and IR-free anode overpotentials. Example 4 showed the best performance. The results clearly confirm the improving effect of appropriate addition of SnO₂ into anode catalyst layer.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A direct oxidation fuel cell (DOFC) comprising:
a cathode electrode;
an anode electrode;
a polymer electrolyte membrane (PEM) sandwiched between the cathode and the anode;
a fuel source containing a highly concentrated fuel in fluid communication with the anode; and
an oxidant in fluid communication with the cathode
wherein:
each of the cathode electrode and anode electrode comprise a catalyst layer and a gas diffusion layer (GDL),
the anode electrode catalyst layer comprises platinum (Pt), ruthenium (Ru) and SnO₂ supported on carbon powder, and
the amount of SnO₂ in the catalyst layer is equal to or lower than about 6.9 wt % relative to total weight of the Pt, Ru and SnO₂ catalyst layer.

2. The DOFC of claim 1, wherein the ratio of Pt:Ru:SnO₂ in the catalyst layer is about 6:6:1.

3. The DOFC of claim 1 wherein the anode electrode catalyst layer further comprises at least one ionomeric polymer, wherein the at least one ionomeric polymer comprises a perfluorosulfonic acid-tetrafluorethylene copolymer having a hydrophobic fluorocarbon backbone and perfluoroether side chains containing a pendant sulfonic acid group (SO₃H).

4. The DOFC of claim 1, further comprising a liquid gas (L/G) separator configured to receive water produced at the cathode and excess fuel from the anode.

5. The DOFC of claim 1, further comprising a controller programmed to control oxidant stoichiometry of the DOFC.

6. The DOFC of claim 1, wherein the anode electrode catalyst layer is deposited on the surface of the GDL.

7. The DOFC of claim 6, wherein the GDL is a porous carbon-based material having a porosity of about 20%-80%.

8. The DOFC of claim 1, wherein the PEM comprises a fluorinated polymer having a perfluorosulfonate group.

9. The DOFC of claim 1, wherein the PEM comprises a hydrocarbon polymer.

10. The DOFC of claim 1, wherein the PEM has a thickness between about 25 μm to about 200 μm.

11. A method of fabricating an anode electrode of a direct oxidation fuel cell (DOFC), comprising:
depositing a fluid catalyst ink layer on a porous carbon based substrate, wherein the fluid catalyst ink layer is formed by combing platinum (Pt), ruthenium (Ru) and SnO₂ supported on a carbon powder, and the amount of SnO₂ in the fluid ink catalyst layer is equal to or lower than 6.9 wt % of the catalyst layer to form an anode electrode for a DOFC.

12. The method of fabricating an anode electrode of DOFC of claim 11, wherein the ratio of Pt:Ru:SnO₂ in the fluid ink catalyst layer is about 6:6:1.

13. The method of fabricating an anode electrode of DOFC of claim 11, wherein the fluid catalyst ink layer further comprises at least one ionomeric polymer, wherein the at least one ionomeric polymer comprises a perfluorosulfonic acid-tetrafluorethylene copolymer having a hydrophobic fluorocarbon backbone and perfluoroether side chains containing a pendant sulfonic acid group (SO₃H).

14. The method of fabricating an anode electrode of a DOFC of claim 11, wherein the DOFC comprises:
a cathode electrode,
a polymer electrolyte membrane (PEM) sandwiched between the cathode and the anode,
a fuel source containing a highly concentrated fuel in fluid communication with the anode, and
an oxidant in fluid communication with the cathode; and
further comprising configuring a liquid gas (L/G) separator is to receive water produced at the cathode and excess fuel from the anode and, wherein the DOFC further comprises an oxidant in fluid communication with the cathode.

15. The method of claim 11, further comprising programming a controller to control oxidant stoichiometry of the DOFC.

16. The method of claim 11, wherein the catalyst layer is deposited on the surface of the GDL.

17. The DOFC of claim 11, wherein the substrate has a porosity of about 20%-80%.

18. An anode electrode for use in a direct oxidation fuel cell, wherein the anode comprises:
a catalyst layer on a porous carbon based substrate, wherein the catalyst layer is formed by combing platinum (Pt), ruthenium (Ru) and SnO₂ supported on a carbon powder, and the amount of SnO₂ in the catalyst layer is equal to or lower than 6.9 wt %.

19. The anode electrode of claim 18, wherein the catalyst layer is deposited on a porous carbon based substrate.

20. The anode electrode of claim 18, wherein the substrate has a porosity of about 20%-80%.
